(19) United States
(12) Patent Application Publication
(10) Pub. No.: US 2022/0096979 A1
(43) Pub. Date: Mar. 31, 2022

(54) PREPARATION METHOD OF CARBON BLACK SYNTHETIC FILTER MATERIALS AND APPLICATION THEREOF

(71) Applicant: Xi'an University of Architecture and Technology, Xi'an City (CN)

(72) Inventors: Xin ZHANG, Xi'an City (CN); Yuesheng FAN, Xi'an City (CN); Shuxuan WEI, Xi'an City (CN); Huan WANG, Xi'an City (CN); Jiaxin ZHANG, Xi'an City (CN)

(21) Appl. No.: 17/226,410

(22) Filed: Apr. 9, 2021

(30) Foreign Application Priority Data
Apr. 9, 2020 (CN) 202010273904.7

(51) Int. Cl. B01D 39/16; B01D 46/00; B01D 39/20; D06M 11/74

(52) U.S. Cl. CPC B01D 39/1623; B01D 46/0001; D06M 2101/32; B01D 39/2055; D06M 11/74; B01D 46/0027

(57) ABSTRACT

The present disclosure provides a preparation method of carbon black synthetic filter materials and an application thereof, which are prepared by impregnating nonwoven fabric filter fibers in a mixed solution consisting of carbon black, animal glue, glycerin, urea, cupric complex of amino acid, Turkey red oil, methylsilicone oil and deionized water, the nonwoven fabric filter fibers are coated with carbon black; wherein, the mixed solution is composed of the following weight parts of raw materials: 2˜4 parts of carbon black, 1˜3 parts of animal glue, 1˜3 parts of glycerin, 0.2˜0.4 parts of urea, 0.03˜0.06 parts of cupric complex of amino acid, 0.05˜0.15 parts of Turkey red oil, 0.05˜0.15 parts of methylsilicone oil, and 45˜55 parts of water. The present disclosure can improve the elimination of contaminants effectively and utilizing the installation space for the current filters efficiently, with strong practical significance and promotion value.

### TECHNICAL FIELD

The present disclosure relates to the index improvement and production technology of filters, which belong to the industry of productive materials, and specifically relates to a preparation method of carbon black synthetic filter materials and an application thereof.

### BACKGROUND

Air pollution seriously affects people's daily life and poses many dangers to people's lives and health. Therefore, people have paid more and more attention to a series of problems caused by air pollution, and it is particularly important to create good indoor environment. Air filters have become one of the most effective ways to overcome indoor pollution. However, the currently available air filters are all composed of filters with different functions, which are used to dispose different types of contaminants. For example, activated carbon is used to remove gaseous contaminants, and the filter fibers are used to remove particulate matters. A composite filter can not only lead to large volume and complicated structure of air filters, but also increase the filter resistance due to the difference in combining form and arrangement, thus causing cost waste. However, the currently available novel filters are difficult to be widely used because of high cost and preparation difficulties. So there is an urgent need for a novel filter material with low cost, easy operation and high efficiency, which can not only meet the requirement of removing gaseous contaminants and solid particulate matters, but also utilize the space of the filter combination efficiently, thereby realizing the win-win effects of cost saving, attractive appearance and rational use of limited space. In addition, carbon black is widely available and accessible in nature, it has a large specific surface area and a good stability, and it's not easy to react with other substances, so it is widely used in removing contaminants. However, there have been few studies on the improvement of nonwoven fiber filter materials with carbon black.

Among the existing technologies, a patent (e.g., Publication No. CN 103768841 A) aims to design a preparation method of an activated carbon filter, in which raw materials are injected into a mold to form a new filter material. Such an invention is mainly used to remove unpleasant odor and free organic compounds in water, but not involving particulate matters and gaseous contaminants in the air. Moreover, its practical effects have not been evaluated deeply, and it cannot solve the existing problems effectively and fundamentally.

Another existing patent (e.g., Publication No. CN 104801109 A) provides a high performance high temperature-resistant glass fiber film-coated nonwoven filtration material and a preparation method thereof. This method can improve the acid and alkali resistance and the folding resistance of base fabrics effectively, thereby further prolonging the service life of the filtration material. However, the filtration efficiency and the actual operating conditions have not been concerned, the actual usage places are relatively specific, and the effects of the common household air filter are relatively deficient. Therefore, there are still many defects.

Some existing patents (e.g., Publication Nos. CN 103966644 A; CN 108793119 A; CN 108840328 A) are intended to design a preparation method of graphene composite film materials. Through improvement on the preparation method, the dispersion uniformity and purity of graphene are enhanced, so that the performance of graphene materials can be utilized more efficiently. However, because graphene materials are expensive relatively and difficult to acquire, and the manufacturing process of the materials is complicated and has high demands on equipment and techniques, so they cannot be used widely.

### SUMMARY

To overcome the defects of the prior art and solve the problem of adopting a combination of filters with different functions in the treatment of contaminants for the currently available air filters, the present disclosure provides a preparation method of carbon black synthetic filter materials and an application thereof.

To achieve the above purposes, the present disclosure provides the following technical solutions:

A preparation method of carbon black synthetic filter materials, including dissolving animal glue in deionized water to form a glue solution, adding carbon black to mix, then adding glycerin, urea, cupric complex of amino acid, Turkey red oil and methylsilicone oil, finally adding deionized water and stirring to form a mixed solution through ultrasonic dispersion;

impregnating nonwoven fabric filter fibers into the mixed solution, then drying them to get the carbon black synthetic filter materials.

Furthermore, the mixed solution is composed of the following weight parts of raw materials: 2˜4 parts of carbon black, 1˜3 parts of animal glue, 1˜3 parts of glycerin, 0.2˜0.4 parts of urea, 0.03˜0.06 parts of cupric complex of amino acid, 0.05˜0.15 parts of Turkey red oil, 0.05˜0.15 parts of methylsilicone oil, and 45˜55 parts of water.

Preferably, the mixed solution is composed of the following weight parts of raw materials: 3 parts of carbon black, 2 parts of animal glue, 2 parts of glycerin, 0.25 parts of urea, 0.05 parts of cupric complex of amino acid, 0.1 parts of Turkey red oil, 0.1 parts of methylsilicone oil, and 45˜55 parts of water.

In particular, the time for impregnation is 2.5˜3.5 h, and the temperature for impregnation is 10˜25° C.

In particular, the drying time is 2.5˜3.5 h, and the drying temperature is 50˜70° C. An application of the carbon black synthetic filter materials prepared by the preparation method of carbon black synthetic filter materials of the present disclosure in removing contaminants in the air, the filtration efficiencies of the carbon black synthetic filter materials on PM_{1.0}, PM_{2.5}, PM₁₀ are enhanced by 16.8%, 28.0% and 11.7%, respectively.

Compared with the prior art, the present disclosure has the following technical effects: The design of the present disclosure is rational, of which the operations are simple and the effects are remarkable. The present disclosure can effectively solve the problem of adopting a combination of filters with different functions in the treatment of contaminants for the currently available air filters, for example: activated carbon is used to remove gaseous contaminants, and the filter fibers are used to remove particulate matters. Such a combination can not only lead to large volume and complicated structure of air filters, but also increase the filter resistance due to the difference in combining form and arrangement, thus causing cost waste.

The present disclosure can solve the disadvantages of the current filter combination efficiently, improve the elimination of contaminants effectively, and utilize the installation space for the current filters efficiently, with strong practical significance and promotion value.

The present disclosure will be further described in detail in combination with the following specific examples.

### BRIEF DESCRIPTION OF THE DRAWINGS

The attached drawings are provided for further understanding of the present disclosure, and constitute a part of the specification, which are used to explain the present disclosure together with the detailed description below, but not constitute a limitation of the present disclosure. In the attached drawings:

FIG. 1 is a schematic diagram of scanning electron microscope at a magnification of 50 according to an example of the present disclosure;

FIG. 2 is a schematic diagram of scanning electron microscope at a magnification of 200 according to an example of the present disclosure;

FIG. 3 is a schematic diagram of scanning electron microscope at a magnification of 1000 before and after synthesis according to an example of the present disclosure;

FIG. 4 is a comparison diagram before and after the synthesis of material objects according to an example of the present disclosure;

FIG. 5 is a schematic diagram showing the filtration efficiencies on particulate matters (PM) according to an example of the present disclosure;

FIG. 6 is a schematic diagram showing particulate matters of different particle sizes according to an example of the present disclosure;

FIG. 7 is a schematic diagram showing the effect of not adding glycerin on the filter materials according to an example of the present disclosure, in which a shows polyester materials, and b shows nonwoven fabric materials;

FIG. 8 shows the drawings of material objects after synthesis according to an example of the present disclosure, in which a shows polyester fiber materials, b shows polyester materials, and c shows nonwoven fabric materials.

### DETAILED DESCRIPTION

The structures, scales, sizes and the like drawn in the attached drawings of the specification are all used to comply with the disclosures of the specification for people familiar with this technology to understand and read, rather than limiting the conditions for the implementation of the present disclosure, so they have no technical significance. Any modifications of the structure, changes of the proportion and adjustments of sizes, without affecting the effects and purposes to be achieved by the present disclosure, should fall within the scope of the technical contents disclosed by the present disclosure.

The carbon black synthetic filter materials of the present disclosure are used to remove contaminants in the air, which can be prepared by impregnating nonwoven fabric filter fibers with a mixed solution composed of carbon black, animal glue, glycerin, urea, cupric complex of amino acid, Turkey red oil, methylsilicone oil and deionized water.

The present disclosure specifies the proportion of main raw materials: the proportion of bone glue:carbon black powder:glycerin:urea:cupric complex of amino acid:Turkey red oil:methylsilicone oil is 40:60:40:5:1:2:2. The weight parts of raw materials are as below: 2˜4 parts of carbon black, 1˜3 parts of animal glue, 1˜3 parts of glycerin, 0.2˜0.4 parts of urea, 0.03˜0.06 parts of cupric complex of amino acid, 0.05˜0.15 parts of Turkey red oil, 0.05˜0.15 parts of methylsilicone oil, and 45˜55 parts of water, respectively. The performance difference of the materials is closely related to the synthesis method of the materials, but the present disclosure is more inclined to practical uses. The present disclosure is intended to solve the problems in the application of the current air filters, which has more practical significance, and especially provides reference for the later study of viruses and other microorganism.

On the basis of the currently conventional air filters commonly applied in the market, by selection through a great deal of impregnating experiments, the present disclosure prepares a novel composite material finally. Moreover, the application and practical effects of the composite material are tested experimentally, with the results showing that the filtering effect on small particles is improved significantly, thereby providing basic parameters of material development for the later research and development of filters for viruses and other microorganism as well as particulate matters. In addition, the synthetic composite material further changes the combination form in which the traditional fiber filters only filter particulate matters and activated carbon only filters gaseous contaminants. The present disclosure can effectively solve the problem of adopting a combination of filters with different functions in the treatment of contaminants for the currently available air filters, overcome the disadvantages of large volume and complicated structure in the current compound filters, and avoid the increasing of filter resistance caused by the difference in combining form and arrangement in case of cost waste. Therefore, the present disclosure not only realizes the elimination of both gaseous contaminants and solid particulate matters, but also reduces the space occupied by compound filters effectively, thus achieving an effect of 1+1>2.

Unless otherwise specified, equipment used in the present disclosure is conventional equipment in the field, and the materials used in the present disclosure are all commercially available.

### Example 1

This example provides a preparation method of carbon black synthetic filter materials and an application thereof, in which the carbon black synthetic filter materials are used to remove contaminants in the air, and are prepared by impregnating nonwoven fabric filter fibers with a mixed solution composed of carbon black, animal glue, glycerin, urea, cupric complex of amino acid, Turkey red oil, methylsilicone oil and deionized water, the nonwoven fabric filter fibers are coated with carbon black; wherein, the mixed solution is composed of the following weight parts of raw materials: 2˜4 parts of carbon black, 1˜3 parts of animal glue, 1˜3 parts of glycerin, 0.2˜0.4 parts of urea, 0.03˜0.06 parts of cupric complex of amino acid, 0.05˜0.15 parts of Turkey red oil, 0.05˜0.15 parts of methylsilicone oil, and 45˜55 parts of water.

In particular, following the above proportions of raw materials, animal glue was dissolved in deionized water to form a glue solution, where the animal glue was bone glue, into which was added carbon black to mix, where the carbon black was Shenling carbon black power of model C311, then added glycerin, urea, cupric complex of amino acid, Turkey red oil and methylsilicone oil, and finally added deionized water and stirred to form a stable mixed solution through ultrasonic dispersion; nonwoven fabric filter fibers were impregnated into the mixed solution, where the time for impregnation was 2.5˜3.5 h, and the temperature for impregnation was 10˜25° C. Then the nonwoven fabric filter fibers after impregnation were dried in an oven to get carbon black synthetic filter materials, where the drying time was 2.5˜3.5 h, and the drying temperature was 50˜70° C. According to the Certification Standards EN779, ISO9001, the filtration grade of the nonwoven fabric filter fibers was certified as F6.

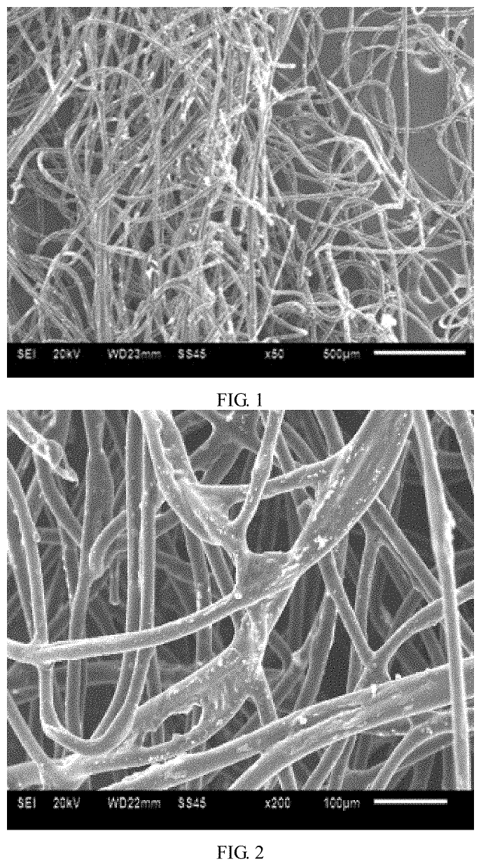

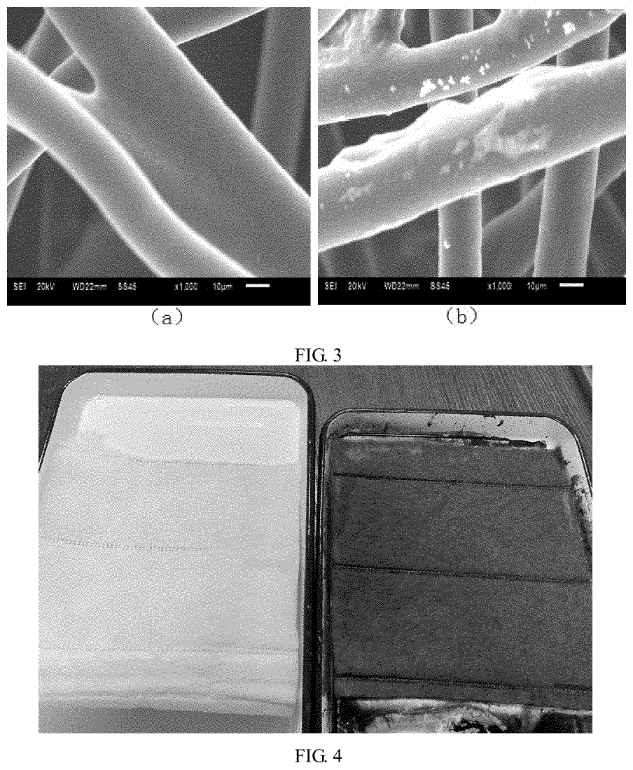

As a preferable example, the mixed solution was composed of the following weight parts of raw materials: 3 parts of carbon black, 2 parts of animal glue, 2 parts of glycerin, 0.25 parts of urea, 0.05 parts of cupric complex of amino acid, 0.1 parts of Turkey red oil, 0.1 parts of methylsilicone oil, and 45˜55 parts of water. The carbon black synthetic filter materials prepared at this proportion were shown in the SEM diagrams of FIGS. 1 and 2, from which it can be seen that the surface of fibers after impregnating with carbon black became rough, the distribution was in the state of manual processing; after impregnating with carbon black, the porosity of fibers is small, but the fibers are dense in structure. After impregnating with carbon black, the surface of each fiber was coated with carbon black to form a carbon black coating. A part of carbon black was deposited on the surface of some fibers, and some crosslinking occurred on the surface of carbon black. There were some wrinkles in the coating and the surface was rough.

### Example 2

The same as Example 1 except that the mixed solution in this example is composed of the following weight parts of raw materials: 2.5 parts of carbon black, 2.2 parts of animal glue, 1.4 parts of glycerin, 0.35 parts of urea, 0.04 parts of cupric complex of amino acid, 0.15 parts of Turkey red oil, 0.05 parts of methylsilicone oil, and 45˜55 parts of water.

### Example 3

The same as Example 1 except that the mixed solution in this example is composed of the following weight parts of raw materials: 3.5 parts of carbon black, 3 parts of animal glue, 2.5 parts of glycerin, 0.3 parts of urea, 0.06 parts of cupric complex of amino acid, 0.05 parts of Turkey red oil, 0.15 parts of methylsilicone oil, and 45˜55 parts of water.

### Example 4

In this example, the carbon black synthetic filter materials prepared in the preferable example 1 was calculated according to the test and corresponding equations, and the filling rate was calculated by measuring the density of the filter material and then calculating the ratio of the density of the filter material to the density of the material used in the filter material.

$$α = \frac{{ρ}_{1}}{{ρ}_{2}}$$

In the equation: α—the filling rate, %; ρ₁—the density of the filtering layer, kg/m³; ρ₂—the density of the material used in the filtering layer, kg/m³.

The relevant parameters of two pieces of nonwoven fabric fiber filter materials were obtained and shown in Table 1.

TABLE 1
Main parameters of experimental samples

| | Grade | | | | Gram | Filling | |
|---|---|---|---|---|---|---|---|
| Grade | (National | | | Specification | weight | rate | Porosity |
| (EN779) | Standards) | No. | Material | (thickness, mm) | (g/m²) | (%) | (%) |
| F6 | Z2 | A | Nonwoven | 25 * 25 * 8 | 12.08 | 4.65 | 95.35 |
| | | | fabrics | | | | |
| | | B | Nonwoven | 25 * 25 * 8 | 5.48 | 2.19 | 97.81 |
| | | | fabrics | | | | |

It can be known from Table 1 that, A is a synthetic material after impregnation, B is a blank control, indicating that after impregnation, the filling rater was increased, the porosity was reduced, the pores among fibers became smaller, thus increasing the chance of capturing particulate matters by the filter materials. Therefore, the improvement on the existing nonwoven fabric fiber materials helps to improve the filtration of fine particulate matters.

An application of the carbon black synthetic filter materials of the present disclosure in removing contaminants in the air, the filtration efficiencies of the carbon black synthetic filter materials on PM_{1.0}, PM_{2.5}, PM₁₀ are enhanced by 16.8%, 28.0% and 11.7%, respectively.

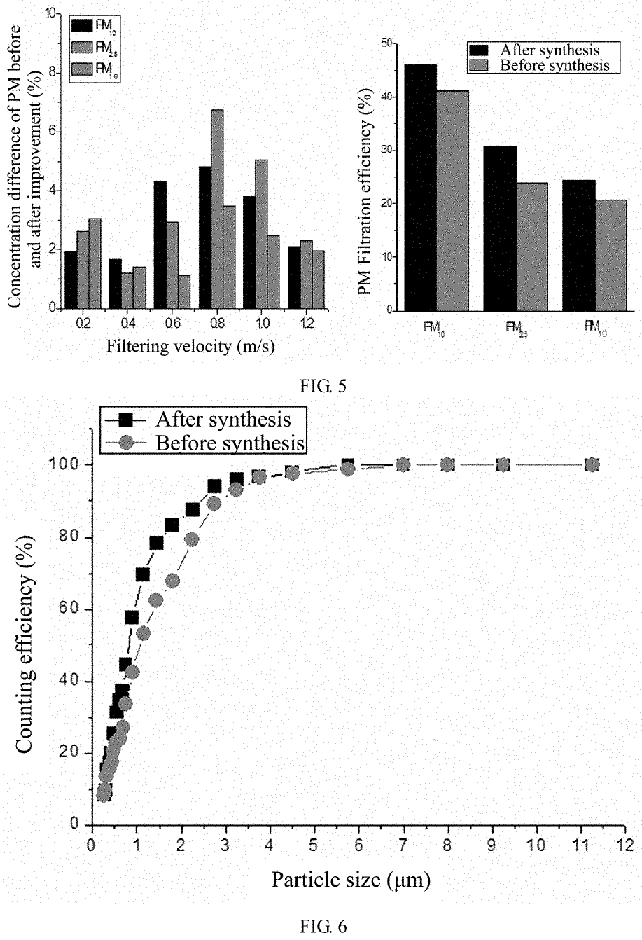

A particulate matter (PM) filtration experiment was performed on the prepared carbon black synthetic filter materials. The PM filtration efficiency difference before and after improvement at different filtering velocities can be seen from FIG. 5. At a filtering velocity of 0.2 m/s, the concentration difference of PM_{1.0} before and after improvement is the maximum 3.04%, which was mainly due to the leading role of Brownian motion as well as the continuous diffusion movement of particles. With the increase of the filtering velocity, the concentration difference of PM₁₀, PM_{2.5}, PM_{1.0} before and after improvement increased gradually, reaching the maximum at 0.8 m/s, at which before and after improvement, the concentration difference of PM₁₀ was 4.81%, the concentration difference of PM_{2.5} was 6.74%, and the concentration difference of PM_{1.0} was 3.48%. The filtration efficiencies on PM_{1.0}, PM_{2.5}, PM₁₀ were enhanced by 16.8%, 28.0%, 11.7% respectively. Therefore, it can be seen that the improved materials had significantly enhanced filtration efficiencies on particulate matters, in particular, the filtration effect on PM_{2.5} was more significant.

The filtration efficiencies of fiber materials before and after synthesis on particulate matters with different particle sizes at a filtering velocity of 0.8 m/s were shown in FIG. 6, from which it can be seen that the filtration efficiencies of fiber materials before and after synthesis increased with the increasing of particle size, and the filtration efficiencies before synthesis were higher than the filtration efficiencies after synthesis. For particulate matters smaller than 0.5 μm, the filtration efficiencies of two pieces of fiber filtration materials were both low, not exceeding 30%. For particulate matters with particle sizes of 0.6˜2.5 μm, the filtration efficiency difference between filtration materials after synthesis and filtration materials before synthesis was in a range of 10%˜20%. And for particulate matters greater than 2.5 μm, the filtration efficiencies of two pieces of fiber filtration materials were comparable. Therefore, the filtration materials after synthesis mainly improve the capture of particulate matters of 0.6˜2.5 μm, this is due to that after the filtration materials after synthesis have been modified with carbon black, the porosity among fibers is reduced, thus increasing the chance of capturing particulate matters. Therefore, the modification on the existing nonwoven fabric fiber materials helps to improve the filtration of fine particulate matters.

An application of the carbon black synthetic filter materials prepared by the preparation method of carbon black synthetic filter materials of the present disclosure in removing contaminants in the air, the filtration efficiencies of the carbon black synthetic filter materials on PM_{1.0}, PM_{2.5}, PM₁₀ are enhanced by 16.8%, 28.0% and 11.7%, respectively.

### Comparative Example 1

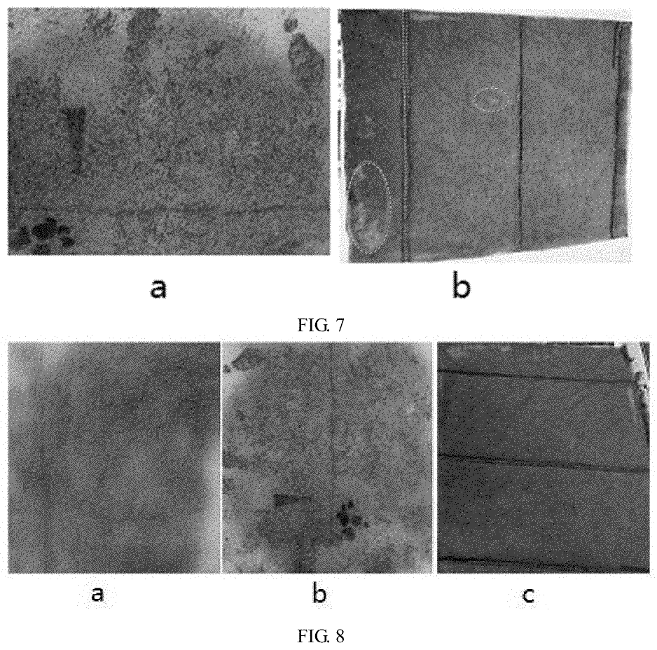

The same as Example 1 except that no glycerin was added in this example, and the prepared carbon black synthetic filter material was shown in FIG. 7. It can be seen from FIG. 7 that in the absence of glycerin, bulky structures were found in both (a) polyester fiber materials and (b) nonwoven fabric materials, and the area was large in some regions. This is due to the widely presence of carbon black in nature, carbon black powder used in the present disclosure exists mainly in the form of small particles, and glycerin acts as a lubricant. Therefore, in the formation of dispersion, if no glycerin is added, the formed dispersion is difficult to disperse without the lubricant and prone to coagulate. The occurrence of bulky coagulation after synthesis is not suitable for practical use, thus affecting the synthesis of materials greatly. Secondly, glycerin makes the dispersant more smooth and uniform, so that the dispersion can bind to the filter materials well during the synthesis of materials, thus enabling the formed materials more stable after drying and not fall off in small wind. In the process of synthesis, if no other auxiliary materials are added after drying, small particles such as carbon black and the like would be only attached to the nonwoven fabrics and fall off directly under a little external force, which may have no effects and fail to meet the desired requirement.

Therefore, by the same principle, Example 1 is the optimal raw material proportion in terms of the selection of various raw materials for the formation of dispersion.

### Comparative Example 2

The same as Example 1 except that the nonwoven fabric filter fibers used in Example 1 were replaced with polyester fiber materials and polyester materials, where the polyester fiber materials and polyester materials as well as the nonwoven fabric filter fibers of the present disclosure are all air filter materials. The impregnating results were shown in FIG. 8, from which it can be seen that, in the same dispersion, the synthetic materials showed different morphologies. The reasons were in that polyester fibers and polyester materials have large porosity, so the solution may flow in the gaps, thus causing uneven impregnation; secondly, there may be solution accumulation because of the connection among fibers, resulting in uneven density after drying, so it is difficult to meet the desired requirement. The structure of nonwoven fabrics is relatively uniform, and there is no large area of non-uniformity and bulky structures in the impregnated materials. Therefore, it is demonstrated through a large amount of experiments that the nonwoven fabrics have relatively good effects.

The purposes, technical solutions and advantages of the present disclosure have been further illustrated in detail in the above examples. It should be noted that the foregoing are only preferable examples of the present disclosure, rather than limiting the present disclosure. Any variations, equivalent replacements and modifications made within the spirit and principle of the present disclosure should be covered within the protection scope of the present disclosure.

The preferable implementation of the present disclosure has been described in detail above in combination with the attached drawings. However, the present disclosure is not limited to the details in the above examples. Various simple variations can be made to the technical solutions of the present disclosure within the technical concept scope of the present disclosure, which all fall within the protection scope of the present disclosure.

It should be further noted that, various specific technical features described in the above detailed description can be combined in any suitable ways without contradiction. To avoid unnecessary duplication, the various possible combinations will not be described separately in this disclosure.

In addition, any combinations of the various different implementations in the present disclosure can also be made, provided that they are not contrary to the thought of this disclosure, and they shall also be considered as the content of the present disclosure.

What is claimed is:

1. A preparation method of carbon black synthetic filter materials, wherein, comprising dissolving animal glue in deionized water to form a glue solution, adding carbon black to mix, then adding glycerin, urea, cupric complex of amino acid, Turkey red oil and methylsilicone oil, finally adding deionized water and stirring to form a mixed solution through ultrasonic dispersion; impregnating nonwoven fabric filter fibers into the mixed solution, then drying them to get the carbon black synthetic filter materials.

2. The preparation method of carbon black synthetic filter materials according to claim 1, wherein, the mixed solution is composed of the following weight parts of raw materials: 2˜4 parts of carbon black, 1˜3 parts of animal glue, 1˜3 parts of glycerin, 0.2˜0.4 parts of urea, 0.03˜0.06 parts of cupric complex of amino acid, 0.05˜0.15 parts of Turkey red oil, 0.05˜0.15 parts of methylsilicone oil, and 45˜55 parts of water.

3. The preparation method of carbon black synthetic filter materials according to claim 1, wherein, the mixed solution is composed of the following weight parts of raw materials: 3 parts of carbon black, 2 parts of animal glue, 2 parts of glycerin, 0.25 parts of urea, 0.05 parts of cupric complex of amino acid, 0.1 parts of Turkey red oil, 0.1 parts of methylsilicone oil, and 45˜55 parts of water.

4. The preparation method of carbon black synthetic filter materials according to claim 1, wherein, the time for impregnation is 2.5˜3.5 h, and the temperature for impregnation is 10˜25° C.

5. The preparation method of carbon black synthetic filter materials according to claim 1, wherein, the drying time is 2.5˜3.5 h, and the drying temperature is 50˜70° C.

6. An application of the carbon black synthetic filter materials prepared by the preparation method of carbon black synthetic filter materials according to claim 1 in removing contaminants in the air, the filtration efficiencies of the carbon black synthetic filter materials on PM_{1.0}, PM_{2.5}, PM₁₀ are enhanced by 16.8%, 28.0% and 11.7%, respectively.

7. The application according to claim 6, wherein, the mixed solution is composed of the following weight parts of raw materials: 2˜4 parts of carbon black, 1˜3 parts of animal glue, 1˜3 parts of glycerin, 0.2˜0.4 parts of urea, 0.03˜0.06 parts of cupric complex of amino acid, 0.05˜0.15 parts of Turkey red oil, 0.05˜0.15 parts of methylsilicone oil, and 45˜55 parts of water.

8. The application according to claim 6, wherein, the mixed solution is composed of the following weight parts of raw materials: 3 parts of carbon black, 2 parts of animal glue, 2 parts of glycerin, 0.25 parts of urea, 0.05 parts of cupric complex of amino acid, 0.1 parts of Turkey red oil, 0.1 parts of methylsilicone oil, and 45˜55 parts of water.

9. The application according to claim 6, wherein, the time for impregnation is 2.5˜3.5 h, and the temperature for impregnation is 10˜25° C.

10. The application according to claim 6, wherein, the drying time is 2.5˜3.5 h, and the drying temperature is 50˜70° C.
